(19) United States
(12) Patent Application Publication
(10) Pub. No.: US 2026/0261645 A1
(43) Pub. Date: Sep. 3, 2026

(54) Devices Associated with a Physical Object

(71) Applicant: Apple Inc., Cupertino, CA (US)

(72) Inventors: Yutaka Yokokawa, Los Gatos, CA (US); Amrutha Hakkare Arunachala, Sunnyvale, CA (US); In Young Yang, Kirkland, WA (US); Joshua J. Frost, Aptos, CA (US); Julian K. Shutzberg, San Francisco, CA (US); Magnus H. Johnson, San Francisco, CA (US)

(21) Appl. No.: 19/460,632

(22) Filed: Jan. 27, 2026

Related U.S. Application Data
(60) Provisional application No. 63/757,581, filed on Feb. 12, 2025.

(51) Int. Cl. H04N 13/361; G06F 3/04815; G06F 3/04817; G06F 3/04842; G06F 3/04847; H04N 13/398

(52) U.S. Cl. CPC H04N 13/361; G06F 3/04815; G06F 3/04817; G06F 3/04842; G06F 3/04847; H04N 13/398

(57) ABSTRACT

In one implementation, a method of displaying multiple status indicators is performed by a device including a display, one or more processors, and non-transitory memory. The method includes associating a first electronic device and a second electronic device with a physical object. The method includes detecting selection of the physical object including detecting a gaze directed to the physical object. The method includes, in response to detecting selection of the physical object, concurrently displaying, on the display, a first status indicator indicating a status of the first electronic device and a second status indicator indicating a status of the second electronic device.

### CROSS-REFERENCES TO RELATED APPLICATIONS

This application claims priority to U.S. Provisional Patent App. No. 63/757,581, filed on Feb. 12, 2025, which is hereby incorporated by reference in its entirety.

### TECHNICAL FIELD

The present disclosure generally relates to systems, methods, and devices of displaying, in an extended reality (XR) environment, status indicators for multiple electronic devices in association with a single physical object.

### BACKGROUND

In various implementations, an extended reality (XR) environment presented by an electronic device including a display includes virtual world-locked objects indicating a status of physical devices in the XR environment to a user of the electronic device. Displaying such objects uses computational resources and can clutter a user’s field-of-view.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIGS. 2A–2E illustrate a first XR environment during various time periods in accordance with some implementations.

FIGS. 3A–3K illustrate a second XR environment during various time periods in accordance with some implementations.

FIG. 4 is a flowchart representation of a method of displaying multiple status indicators in accordance with some implementations.

FIG. 5 is a block diagram of an example controller in accordance with some implementations.

FIG. 6 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for displaying multiple status indicators. In various implementations, the method is performed by a device having a display, one or more processors, and non-transitory memory. The method includes associating a first electronic device and a second electronic device with a physical object. The method includes detecting selection of the physical object including detecting a gaze directed to the physical object. The method includes in response to detecting selection of the physical object, concurrently displaying, on the display, a first status indicator indicating a status of the first electronic device and a second status indicator indicating a status of the second electronic device.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, in various implementations, an XR environment can include virtual world-locked objects indicating the status of physical devices in the XR environment and/or including controls for changing the status of the physical devices. However, displaying such objects for each physical device in the XR environment uses computational resources and can clutter a user’s field-of-view. Accordingly, in various implementations, such objects are only displayed when a user selects the physical device, e.g., by looking at the physical device, gesturing at the physical device, vocally indicating the physical device, etc. In various implementations, such virtual world-locked objects are displayed when a user selects a physical object associated with the physical device. For example, a virtual object for controlling a smart lightbulb may be displayed when a user selects a lamp including the smart lightbulb. As another example, a virtual object for controlling a smart plug may be displayed when a user selects a physical object plugged into the smart plug. As another example, a virtual object for displaying the status of a doorbell may be displayed when a user selects a door.

In various implementations, multiple physical devices may be associated with the same physical object. For example, both a ceiling fan and a ceiling light may be associated with the same ceiling fixture. As another example, a doorbell, a camera, a lock, and a porch light may be associated with the same front door. Accordingly, when a user selects a physical object associated with multiple physical devices, one or more virtual objects for displaying the status of or controlling one or more of the multiple physical devices are concurrently displayed.

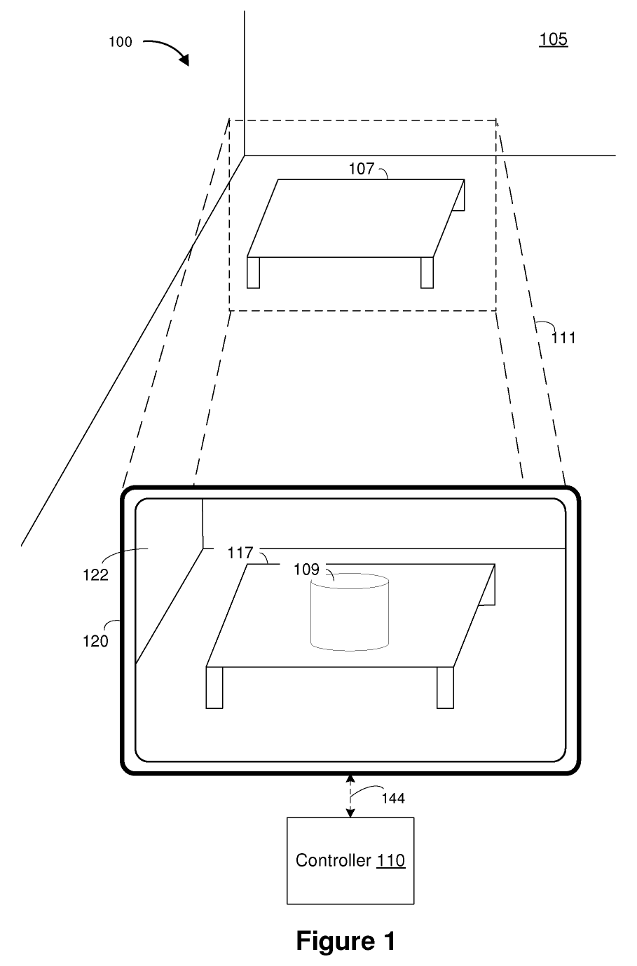

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

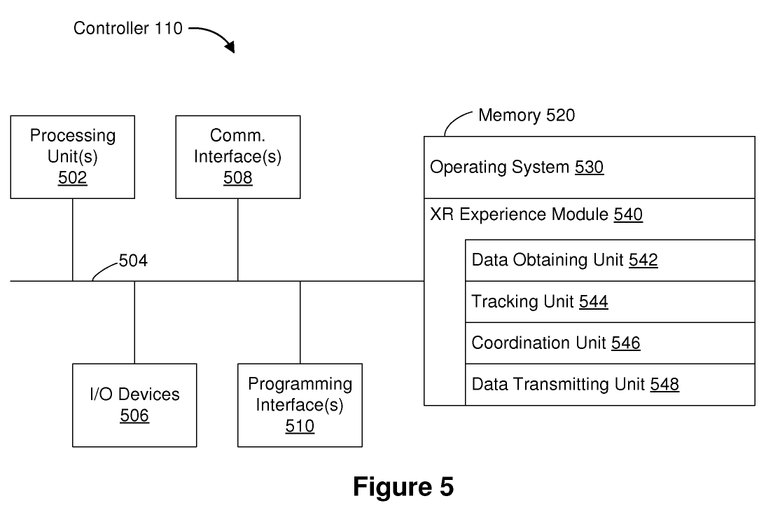

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 5. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

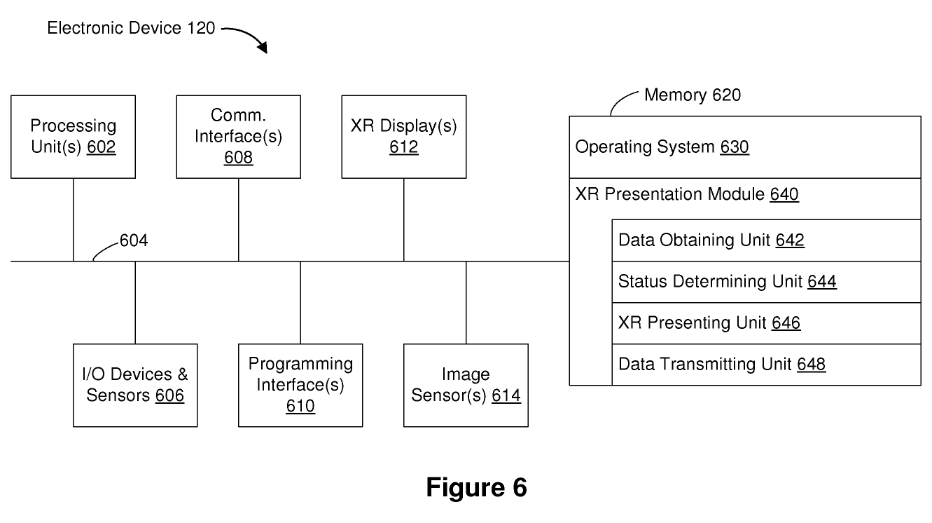

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is virtually or physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 6.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

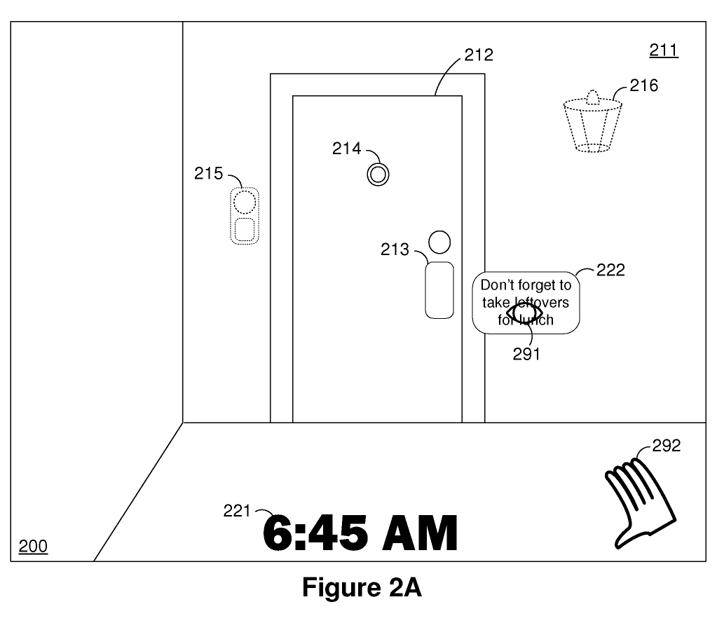

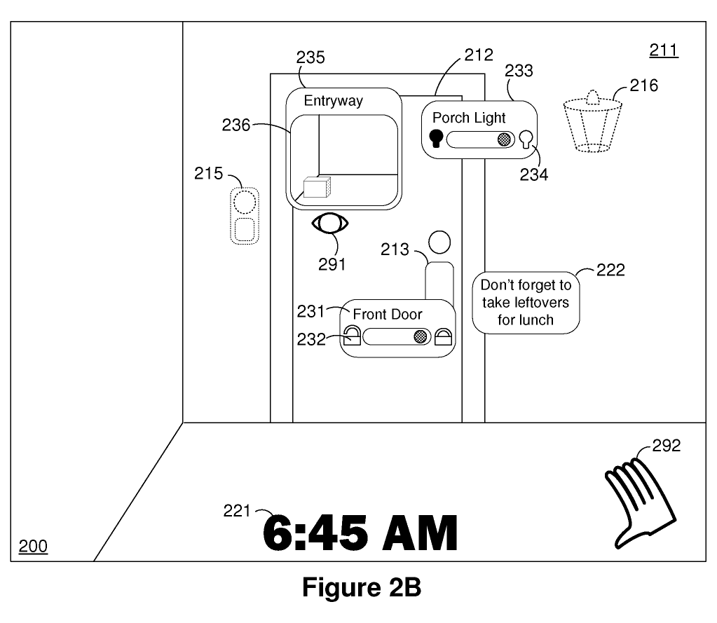

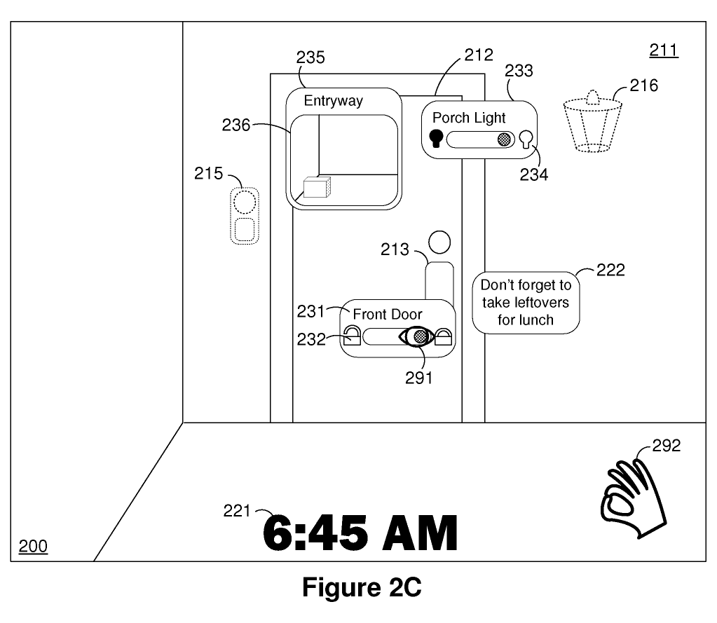

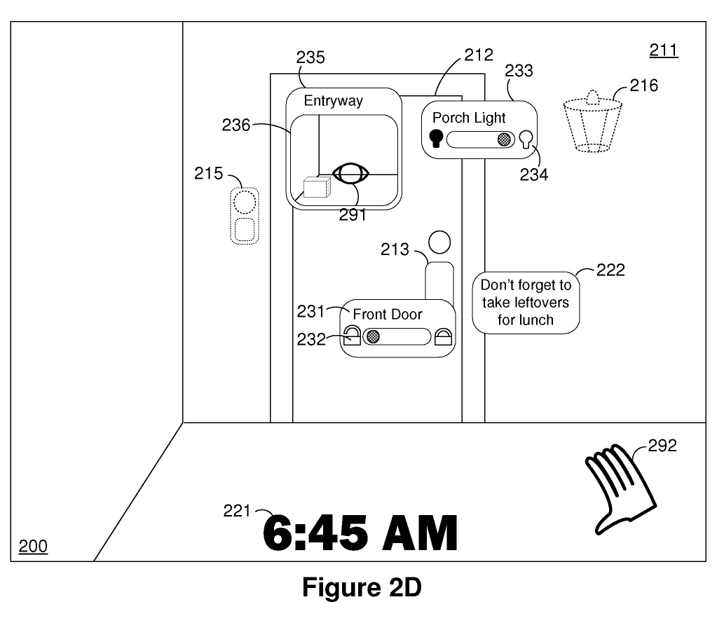

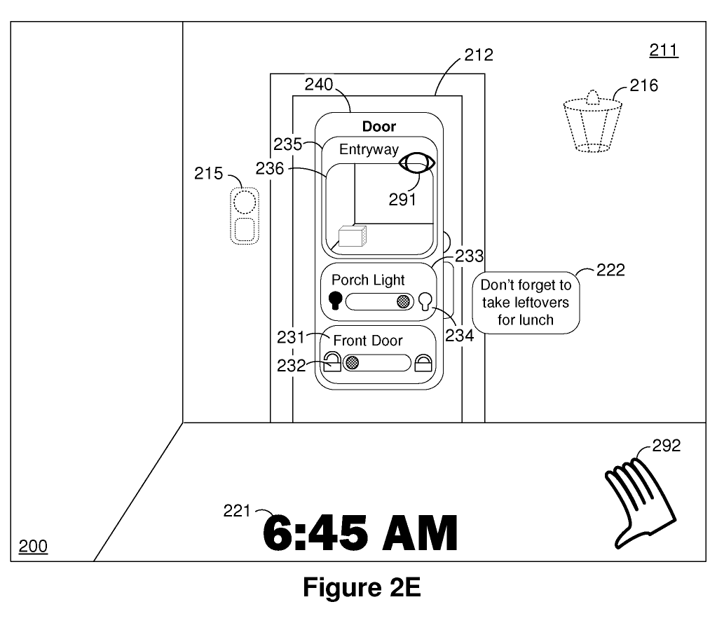

FIGS. 2A–2E illustrate a first XR environment 200 based on a physical environment of an entryway from the perspective of a user of an electronic device displayed, at least in part, by a display of the electronic device. In various implementations, the electronic device includes multiple displays (e.g., a left display positioned in front of a left eye of a user and a right display positioned in front of a right eye of the user) configured to provide a stereoscopic view of the first XR environment 200. For ease of illustration, FIGS. 2A–2E illustrate the first XR environment 200 as presented on a single one of the multiple displays.

In various implementations, the perspective of the user is from a location of an image sensor of the electronic device. For example, in various implementations, the electronic device is a handheld electronic device and the perspective of the user is from a location of the image sensor of the handheld electronic device directed towards the physical environment. In various implementations, the perspective of the user is from the location of a user of the electronic device. For example, in various implementations, the electronic device is a head-mounted electronic device and the perspective of the user is from a location of the user directed towards the physical environment, generally approximating the field-of-view of the user if the head-mounted electronic device were not present. In various implementations, the perspective of the user is from the location of an avatar of the user. For example, in various implementations, the first XR environment 200 is a virtual environment and the perspective of the user is from the location of an avatar or other representation of the user directed towards the virtual environment.

FIGS. 2A–2E illustrate the first XR environment 200 during a series of time periods. In various implementations, each time period is an instant, a fraction of a second, a few seconds, a few hours, a few days, or any length of time.

The first XR environment 200 includes a plurality of objects, including one or more real objects (e.g., a wall 211, a front door 212, a lock 213 installed in the front door 212, a peephole 214 installed in the front door 212, a camera 215 on the opposite side of the wall 211 imaging a porch region beyond the front door 212, a porch light 216 on the opposite side of the wall 211 able to illuminate the porch region, and a hand 292) and one or more virtual objects (e.g., a virtual clock 221 and a virtual reminder 222).

In various implementations, certain objects (such as the real objects and the virtual reminder 222) are presented at a location in the first XR environment 200, e.g., at a location defined by three coordinates in a three-dimensional (3D) XR coordinate system. Accordingly, when the electronic device moves in the first XR environment 200 (e.g., changes either position and/or orientation), the objects are moved on the display of the electronic device, but retain their (possibly time-dependent) location in the first XR environment 200. Such virtual objects that, in response to motion of the electronic device, move on the display, but retain their position in the first XR environment 200 are referred to as world-locked objects. In various implementations, certain virtual objects (such as the virtual clock 221) are displayed at locations on the display such that when the electronic device moves in the first XR environment 200, the objects are stationary on the display on the electronic device. Such virtual objects that, in response to motion of the electronic device, retain their location on the display are referred to as head-locked objects or display-locked objects.

FIGS. 2A–2E illustrate a gaze location indicator 291 that indicates a gaze location of the user, e.g., where in the first XR environment 200 the user is looking. Although the gaze location indicator 291 is illustrated in FIGS. 2A–2E, in various implementations, the gaze location indicator 291 is not displayed by the electronic device.

FIG. 2A illustrates the first XR environment 200 during a first time period. During the first time period, the user is looking at the virtual reminder 222 (as indicated by the gaze location indicator 291) and the hand 292 is in a neutral position.

FIG. 2B illustrates the first XR environment 200 during a second time period subsequent to the first time period. During the second time period, the user is looking at the front door 212 (as indicated by the gaze location indicator 291) and the hand 292 is in a neutral position. The electronic device detects that the user is looking at the front door 212 and, in response, displays a number of device status windows indicating the status of a number of physical devices associated with the front door 212. In particular, the electronic device displays a lock status window 231 indicating a status of the lock 213 with a lock status indicator 232. In FIG. 2B, the lock status indicator indicates that the lock 213 has a “locked” status. In various implementations (as described below), the user can interact with the lock status indicator 232 to change the status of the lock 213 (e.g., to an “unlocked” status).

Simultaneously, the electronic device displays a porch light status window 233 indicating a status of the porch light 216 with a porch light status indicator 234. In FIG. 2B, the porch light status indicator 234 indicates that the porch light 216 has an “on” status. In various implementations, the user can interact with the porch light status indicator 234 to change the status of the porch light 216 (e.g., to an “off” status). Although, in FIG. 2B, the porch light status window 233 includes only a single porch light status indicator 234, in various implementations, the porch light status window 233 can include more than one status indicator, such as a status indicator for indicating (and allowing a change of) the color of light emitted by the porch light 216.

Further, the electronic device simultaneously displays a camera status window 235 indicating a status of the camera 215 with an image display 236. The image display 236 displays a current (or most recent) image captured by the camera 215. Although, in FIG. 2B, the camera status window 235 includes only the image display 236, in various implementations, the camera status window 235 can include more than one status indicator, such as a status indicator for indicating a battery level of the camera 215.

FIG. 2C illustrates the first XR environment 200 during a third time period subsequent to the second time period. During the third time period, the user activates the lock status indicator 232 (e.g., by gazing at the lock status indicator 232 as indicated by the gaze location indicator 291 and performing a gesture with the hand 292).

FIG. 2D illustrates the first XR environment 200 during a fourth time period subsequent to the third time period. In response to detecting the user activating the lock status indicator 232, the electronic device transmits a command to the lock 213 to change from a “locked” status to an “unlocked” status. In response to receiving such a command, the lock 213 changes its status. Accordingly, in FIG. 2D, the lock status indicator 232 indicates that the lock 213 has an “unlocked” status.

In FIG. 2D, the lock status window 231, the porch light status window 233, and the camera status window 235 are displayed concurrently, but separately. For example, in FIG. 2D, the lock status window 231 is displayed proximate to the lock 213, the porch light status window 233 is displayed proximate to the porch light 216, and the camera status window 235 is displayed proximate to the peephole 214. In various implementations, the status windows are world-locked objects and the location in the first XR environment 200 at which the status windows are displayed can be configured by a user during an enrollment process associating a physical device (such as the lock 213) with a physical object (such as the front door 212).

However, in various implementations, the lock status window 231, the porch light status window 233, and the camera status window 235 are displayed concurrently and together. FIG. 2E illustrates an alternative embodiment of the first XR environment 200 during the fourth time period. In FIG. 2E, the lock status window 231, the porch light status window 233, and the camera status window 235 are displayed within a door status window 240.

In FIG. 2E (and in FIG. 2D), the lock status window 231, the porch light status window 233, and the camera status window 235 are each displayed when the user looks at the front door 212. In various implementations, when a user looks at the front door 212, the electronic device selects a subset of the physical devices associated with the front door 212 and displays status windows only for the physical devices of the subset. The electronic device may employ various heuristics for determining which status windows to display. For example, in various implementations, the electronic device only displays the camera status window 235 if motion has been recently detected (or was detected since the front door 212 was last opened as indicated by the lock 213 or another physical device associated with the front door 212 such as an alarm system). As another example, in various implementations, the electronic device only displays the porch light status window 233 if the porch light 216 is on during the day (and would have a status that is difficult to determine by looking through the peephole 214 or at the image display 236).

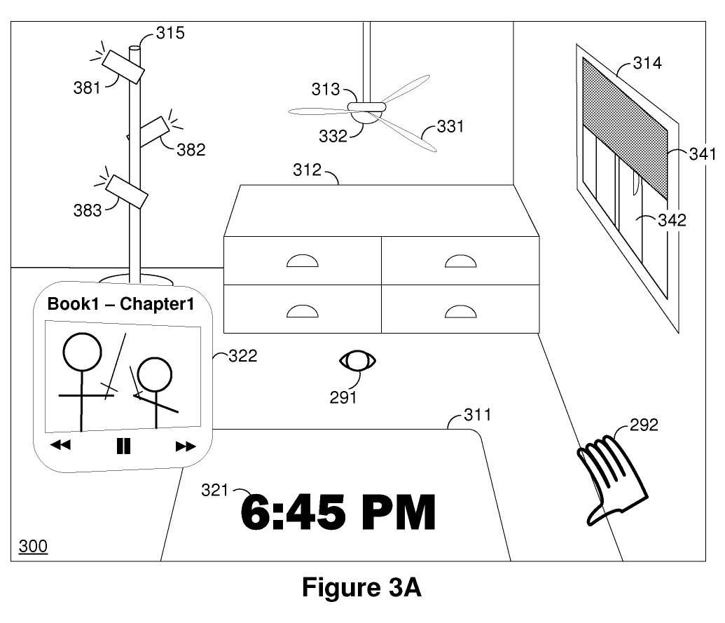

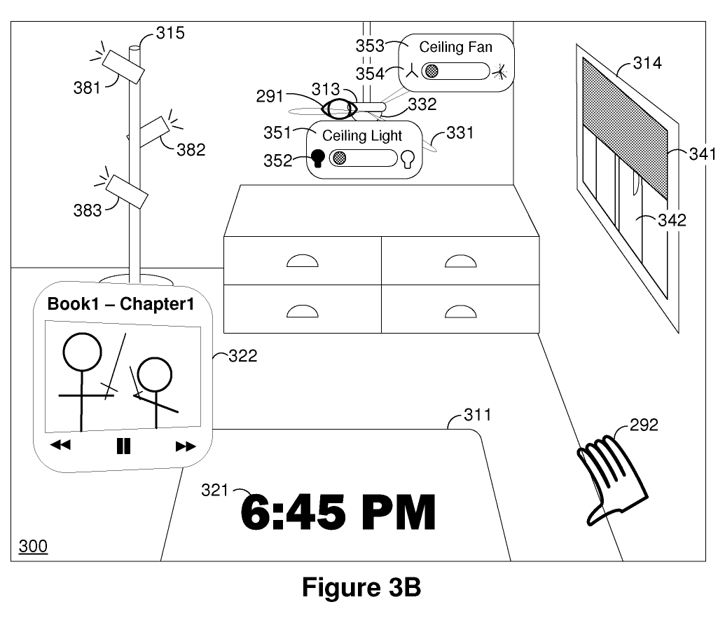

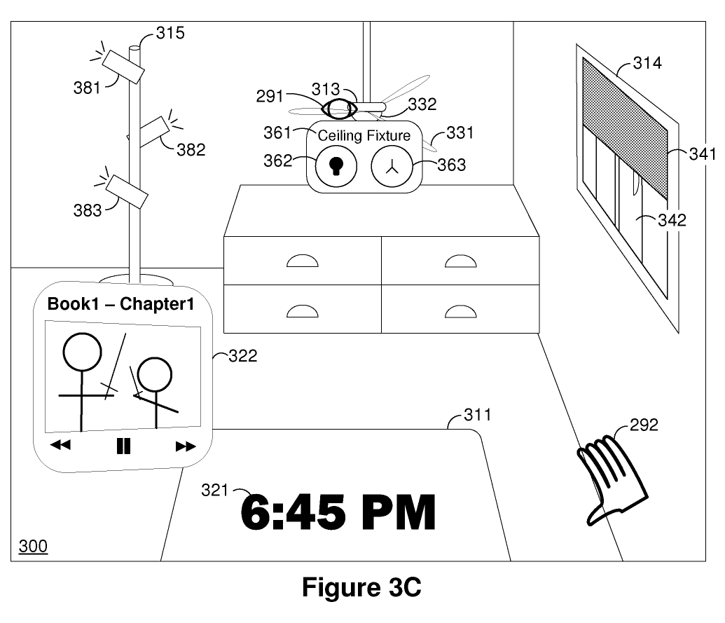

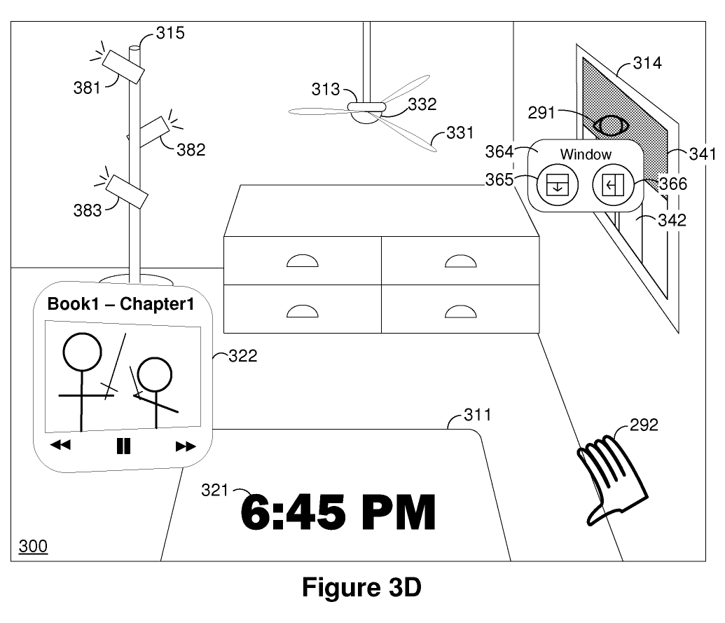

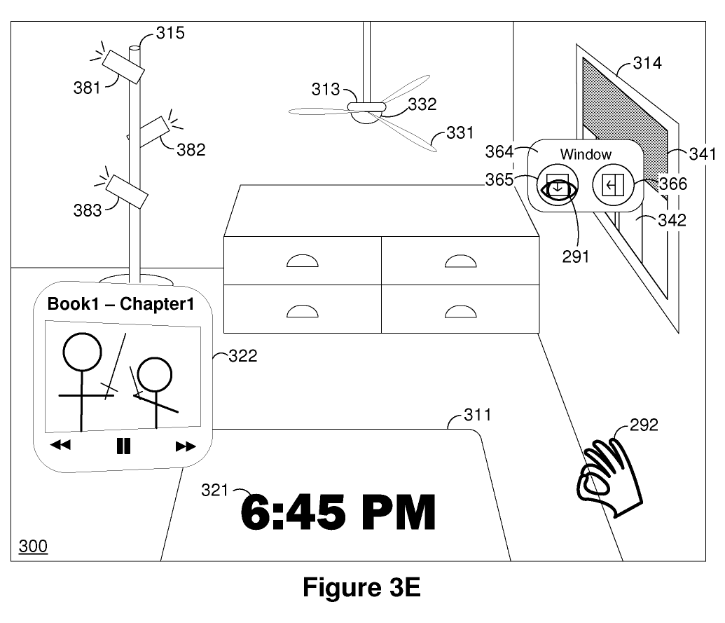

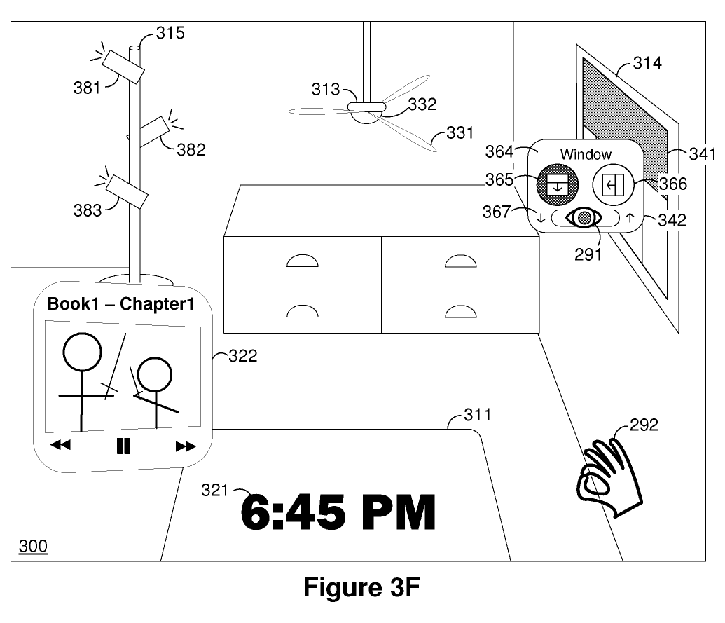

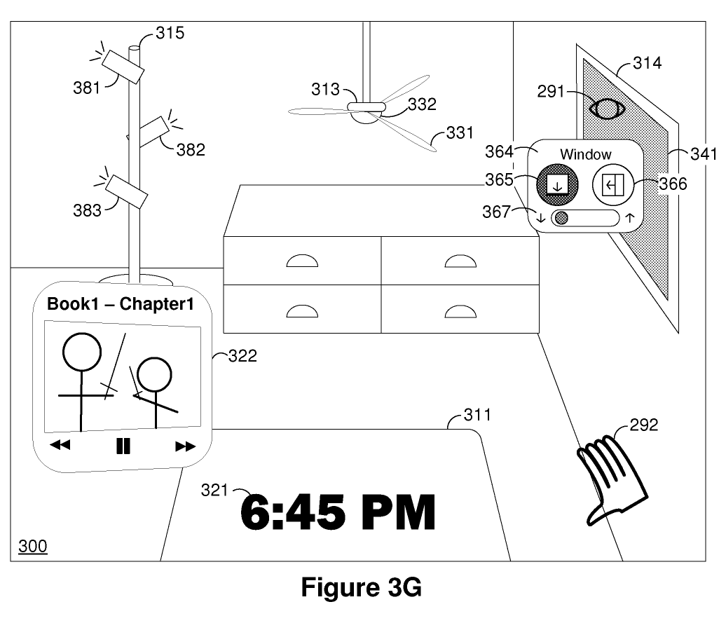

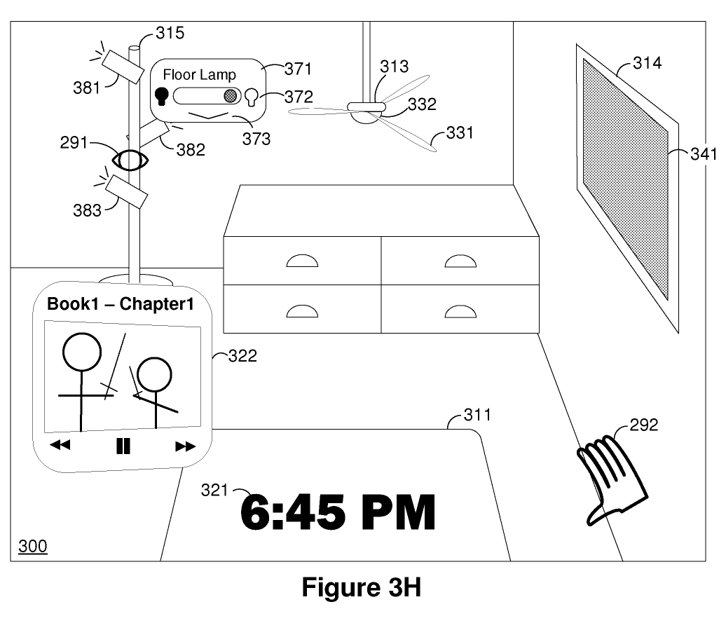

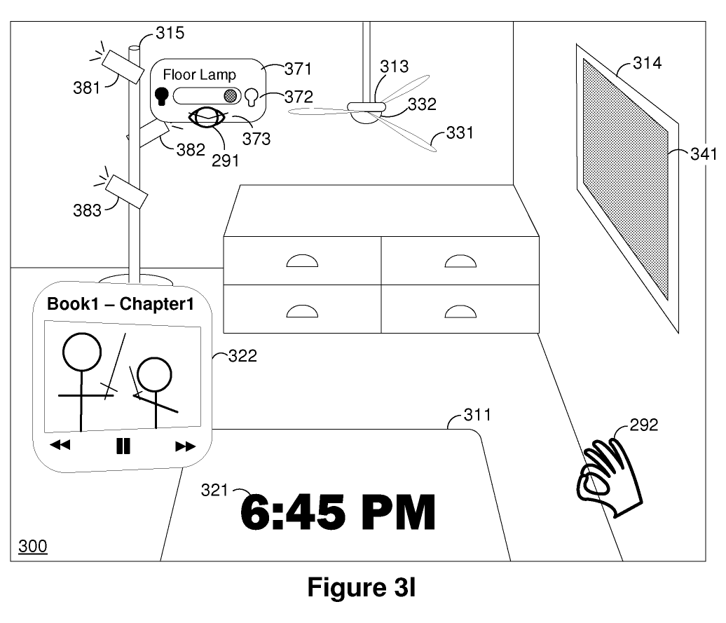

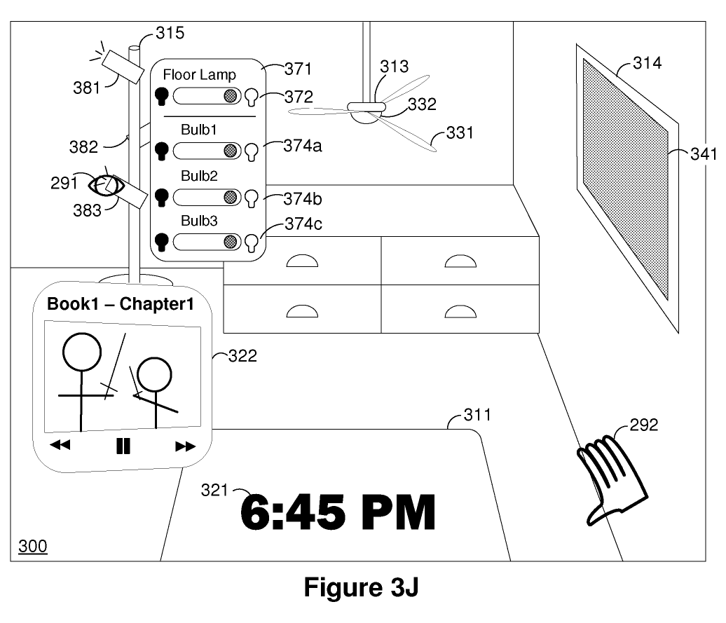

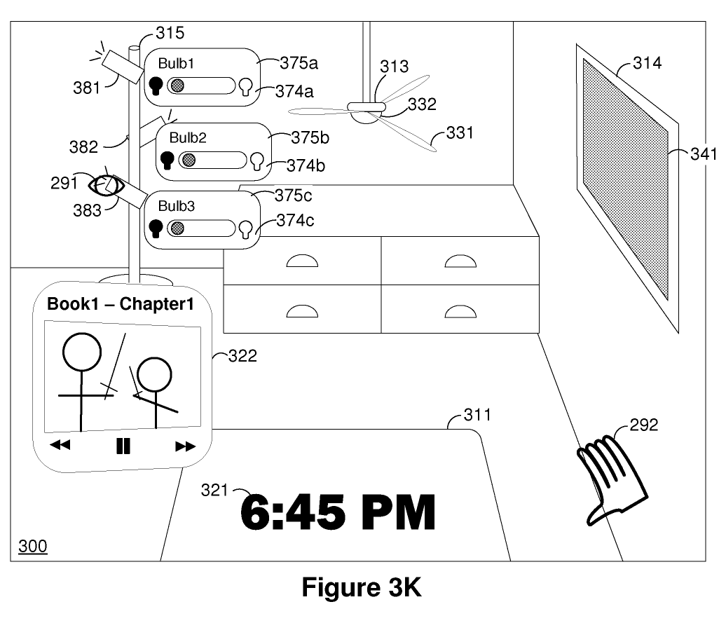

FIGS. 3A–3K illustrate a second XR environment 300 based on a physical environment of a bedroom from the perspective of a user of an electronic device displayed, at least in part, by a display of the electronic device. In various implementations, the electronic device includes multiple displays (e.g., a left display positioned in front of a left eye of a user and a right display positioned in front of a right eye of the user) configured to provide a stereoscopic view of the second XR environment 300. For ease of illustration, FIGS. 3A–3K illustrate the second XR environment 300 as presented on a single one of the multiple displays.

FIGS. 3A–3K illustrate the second XR environment 300 during a series of time periods. In various implementations, each time period is an instant, a fraction of a second, a few seconds, a few hours, a few days, or any length of time.

The second XR environment 300 includes a plurality of objects, including one or more real objects (e.g., a bed 311, a dresser 312, a ceiling fixture 313, a window 314, a floor lamp 315, and the hand 292) and one or more virtual objects (e.g., a virtual clock 321 and a virtual audiobook player 322). The ceiling fixture 313 includes a ceiling fan 331 and a ceiling light 332. The window 314 includes blinds 341 and a shutter 342. The floor lamp 315 includes a first bulb 381, a second bulb 382, and a third bulb 383.

In various implementations, certain objects (such as the real objects and the virtual audiobook player 322) are world-locked objects. In various implementations, certain virtual objects (such as the virtual clock 321) are display-locked objects.

FIGS. 3A–3K illustrate the gaze location indicator 291 that indicates a gaze location of the user, e.g., where in the second XR environment 300 the user is looking. Although the gaze location indicator 291 is illustrated in FIGS. 3A–3K, in various implementations, the gaze location indicator 291 is not displayed by the electronic device.

FIG. 3A illustrates the second XR environment 300 during a first time period. During the first time period, the user is looking at a neutral location (e.g., the floor as indicated by the gaze location indicator 291) and the hand 292 is in a neutral position.

FIG. 3B illustrates the second XR environment 300 during a second time period subsequent to the first time period. During the second time period, the user is looking at the ceiling fixture 313 (as indicated by the gaze location indicator 291) and the hand 292 is in a neutral position. The electronic device detects that the user is looking at the ceiling fixture 313 and displays a number of device status windows indicating the status of a number of physical devices associated with the ceiling fixture 313. In particular, the electronic device displays a ceiling light status window 351 indicating a status of the ceiling light 332 with a ceiling light status indicator 352. In FIG. 3B, the ceiling light status indicator indicates that the ceiling light 332 has an “off” status. In various implementations, the user can interact with the ceiling light status indicator 352 to change the status of the ceiling light 332 (e.g., to an “on” status). Although, in FIG. 3B, the ceiling light status window 351 includes only a single ceiling light status indicator 352, in various implementations, the ceiling light status window 351 can include more than one status indicator, such as a status indicator for indicating (and allowing a change of) the temperature of light emitted by the ceiling light 332.

Simultaneously, the electronic device displays a ceiling fan status window 353 indicating a status of the ceiling fan 331 with a ceiling fan status indicator 354. In FIG. 3B, the ceiling fan status indicator 354 indicates that the ceiling fan 331 has an “off” status. In various implementations, the user can interact with the ceiling fan status indicator 354 to change the status of the ceiling fan 331 (e.g., to an “on” status or to a “low”, “middle”, or “high” status).

In FIG. 3B, the ceiling light status window 351 and the ceiling fan status window 353 are displayed concurrently, but separately. For example, in FIG. 3B, the ceiling light status window 351 is displayed towards the center of the ceiling fixture 313 proximate to the ceiling light 332 and the ceiling fan status window 535 is displayed out from the center of the ceiling fixture 313 and proximate to blades of the ceiling fan 331. In various implementations, the status windows are world-locked objects and the location in the second XR environment 300 at which the status windows are displayed can be configured by a user during an enrollment process associating a physical device (such as the ceiling light 332) with a physical object (such as the ceiling fixture 313).

Thus, the ceiling light status indicator 352 and the ceiling fan status indicator 354 are displayed in separate windows. However, in various implementations, the ceiling light status indicator 352 and the ceiling fan status indicator 354 are displayed within the same window. FIG. 3C illustrates an alternative embodiment of the second XR environment 300 during the second time period. In FIG. 3C, a ceiling fixture status window 361 includes a ceiling light status icon 362 that indicates the status of the ceiling light 332 (as an alternative to the ceiling light status indicator 352 of FIG. 3B) and a ceiling fan status icon 363 that indicates the status of the ceiling fan 331 (as an alternative to the ceiling fan status indicator 354 of FIG. 3B). In various implementations, the user can interact with the ceiling light status icon 362 to change the status of the ceiling light 332 and/or interact with the ceiling fan status icon 363 to change the status of the ceiling fan 331.

FIG. 3D illustrates the second XR environment 300 during a third time period subsequent to the second time period. During the third time period, the user is looking at the window 314 (as indicated by the gaze location indicator 291) and the hand 292 is in a neutral position. The electronic device detects that the user is looking at the window 314 and, in response, displays a window status window 364 that includes a blinds status indicator icon 365 indicating a status of the blinds 341 and a shutter status indicator icon 366 indicating a status of the shutter 342. In FIG. 3D, the blinds status indicator icon 365 indicates that the blinds 341 are half-lowered (or half-raised) and the shutter status indicator icon 366 indicates that the shutter 342 is half-closed (or half-opened). Although, in FIG. 3D, the window status window 364 includes only a single blinds status indicator icon 365 and a single shutter status indicator icon 366, in various implementations, the window status window 364 can include more than one status indicator for each physical device, such as a status indicator for openness or closeness (e.g., a transmissivity) of the blinds 341 or a status indicator for a tint (e.g., a transmissivity) of the shutter 342. Such status indicators (and any status indicators described herein) can include an icon, a slider, text, or other graphics.

FIG. 3E illustrates the second XR environment 300 during a fourth time period subsequent to the third time period. During the fourth time period, the user activates the blinds status indicator icon 365 (e.g., by gazing at the blinds status indicator icon 365 as indicated by the gaze location indicator 291 and performing a gesture with the hand 292).

FIG. 3F illustrates the second XR environment 300 during a fifth time period subsequent to the fourth time period. In response to detecting the user activating the blinds status indicator icon 365, the window status window 364 includes a blinds status indicator 367 in the form of a slider for more exact control of the raised/lowered status of the blinds 341. During the fifth time period, the user activates the blinds status indicator 367 to lower the blinds 341 (e.g., by gazing at the blinds status indicator 367 as indicated by the gaze location indicator 391 and perform a gesture with the hand 292 moving left).

FIG. 3G illustrates the second XR environment 300 during a sixth time period subsequent to the fifth time period. In response to detecting the user activate the blinds status indicator 367 to lower the blinds 341, the electronic device transmits a command to the blinds 341 to change to a “lowered” status. In response to receiving such a command, the blinds 341 change their status. Accordingly, in FIG. 3G, the blinds 341 are lowered and the blinds status indicator 367 indicates that the lock has an “unlocked” status.

FIG. 3H illustrates the second XR environment 300 during a seventh time period subsequent to the sixth time period. During the seventh time period, the user is looking at the floor lamp 315 (as indicated by the gaze location indicator 291) and the hand 292 is in a neutral position. The electronic device detects that the user is looking at the floor lamp 315 and, in response, displays a floor lamp status window 371 that includes a floor lamp status indicator 372 indicating a status of the floor lamp 315. In FIG. 3H, the floor lamp status indicator 372 indicates that the floor lamp 315 is on (e.g., that the first bulb 381, second bulb 382, and third bulb 383 are on). In response to the user activating the floor lamp status indicator 372, the electronic device transmits a command to each of the first bulb 381, second bulb 382, and third bulb 383 to change from an “on” status to an “off” status.

For more refined control, the floor lamp status window 371 further includes an expand affordance 373. FIG. 3I illustrates the second XR environment 300 during an eighth time period subsequent to the seventh time period. During the eighth time period, the user activates the expand affordance 373 (e.g., by gazing at the expand affordance 373 as indicated by the gaze location indicator 291 and perform a gesture with the hand 292).

FIG. 3J illustrates the second XR environment 300 during a ninth time period subsequent to the eighth time period. During the ninth time period, in response to detecting the user activate the expand affordance, the floor lamp status window 371 includes a first bulb status indicator 374a indicating a status of the first bulb 381, a second bulb status indicator 374b indicating a status of the second bulb 382, and a third bulb status indicator 374c indicating a status of the third bulb 383. In response to the user activating any of the bulb status indicators 374a–374c, the electronic device transmits a command to the corresponding bulb (and not the others) to change from an “on” status to an “off” status.

FIG. 3K illustrates an alternative embodiment of the second XR environment 300 during the ninth time period. In FIG. 3K, during the ninth time period, in response to detecting the user activate the expand affordance, the floor lamp status window 371 is replaced with a first bulb status window 375a including the first bulb status indicator 374a, a second bulb status window 375b including the second bulb status indicator 374b, and a third bulb status window 375c including the third bulb status indicator. Although each bulb status window includes only a single status indicator, each bulb status window can include more than one status indicator, such as a status indicator for indicating (and allowing a change of) the color of light emitted by the corresponding bulb.

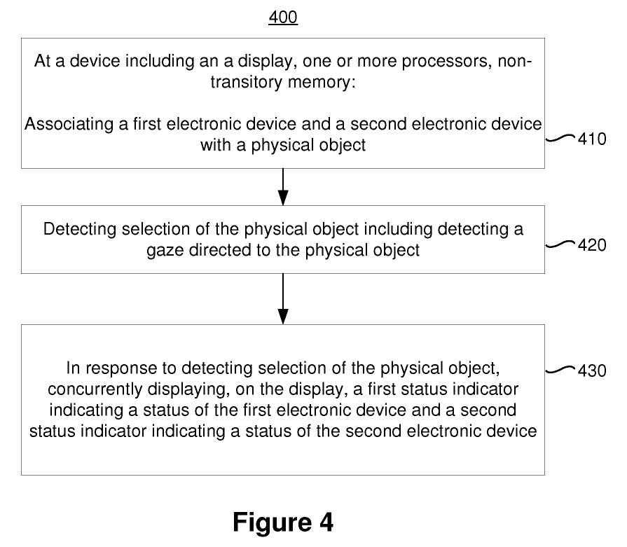

FIG. 4 is a flowchart representation of a method 400 of concurrently displaying multiple status indicators in accordance with some implementations. In various implementations, the method 400 is performed by an electronic device, such as the electronic device 120 of FIG. 1. In various implementations, the method 400 is performed by a device having an image sensor, a display, one or more processors, and non-transitory memory. In some implementations, the method 400 is performed by processing logic, including hardware, firmware, software, or a combination thereof. In some implementations, the method 400 is performed by a processor executing instructions (e.g., code) stored in a non-transitory computer-readable medium (e.g., a memory).

The method 400 begins, in block 410, with the device associating a first electronic device and a second electronic device with a physical object. In various implementations, the first electronic device is associated with the physical object during an enrollment process.

In various implementations, in various implementations, the object model is an image of the physical object. In various implementations, the object model is a three-dimensional model (e.g., including vertices and edges) of the physical object. In various implementations, the object model is an embedding of the physical object in a high-dimensional vector space. In various implementations, the object model is associated with an object identifier. In various implementations, the object identifier is associated with an object label, which may be generated by the device or provided by a user. For example, in FIGS. 3A–3K, the ceiling fixture 313 has an object label of “Ceiling Fixture” as displayed in the ceiling fixture window 361.

In various implementations, the first electronic device is associated with a first device identifier. In various implementations, the first device identifier is a first MAC address. In various implementations, the first device identifier is a first IP address. In various implementations, the first electronic device is associated with a first device label, which may be generated by the device or provided by a user. For example, in FIGS. 3A–3K, the ceiling light 332 has a first device label of “Ceiling Light” as displayed in ceiling light status window 351.

Thus, in various implementations, the device associates the object model, the object identifier, and/or the object label with the first device identifier and/or the first device label.

Further, during the enrollment process (or a separate enrollment process), the second electronic device is associated with the physical object. In various implementations, the second electronic device is associated with a second device identifier. In various implementations, the second device identifier is a second MAC address. In various implementations, the second device identifier is a second IP address. In various implementations, the second electronic device is associated with a second device label, which may be generated by the device or provided by a user. For example, in FIGS. 3A–3K, the ceiling fan 331 has a second device label of “Ceiling Fan” as displayed in ceiling fan status window 353.

Thus, in various implementations, the device also associates the object model, the object identifier, and/or the object label with the second device identifier and/or the second device label.

For example, in FIGS. 2A–2E, the lock 213, the camera 215, and the porch light 216 are associated with the front door 212. As another example, in FIGS. 3A–3K, the ceiling light 332 and the ceiling fan 331 are associated with the ceiling fixture 313. As another example, in FIGS. 3A–3K, the blinds 341 and the shutter 342 are associated with the window 314. As another example, in FIGS. 3A–3K, the first bulb 381, the second bulb 382, and the third bulb 383 are associated with the floor lamp 315.

In various implementations, the first electronic device has a first device type and the second electronic device has a second device type different than the first device type. Similarly, in various implementations, the first electronic device has a first status type that is a first status and the second electronic device has a second status type, different than the first status type, that is a second status. For example, in FIGS. 2A–2E, the lock 213, the camera 215, and the porch light 216 each have a different device type. For example, the lock 213 has a “lock” device type that has a “locked” or “unlocked” status, whereas the porch light 216 has a “light” device type that has an “on” or “off” status (and, perhaps additionally, a color status). Further, the camera 215 has a “camera” device type that has an image as a status. As another example, the ceiling light 332 and the ceiling fan 331 have different device types. For example, the ceiling light 332 has a “light” device type that has an “on” or “off” status (and, perhaps additionally, a color status), whereas the ceiling fan 331 has a “fan” device type that has a fan speed status which may be “off”, “low”, “middle”, or “high”.

In various implementations, the first electronic device and the second electronic device are within a threshold distance of the physical object. For example, in FIGS. 2A–2E, the camera 215 and porch light 216 are within a threshold distance of the front door 212. In various implementations, the first electronic device and the second electronic device are within the physical object (as defined by the object model). For example, in FIGS. 3A–3K, the ceiling light 332 and the ceiling fan 331 are within the ceiling fixture 313. As another example, in FIGS. 3A–3K, the blinds 341 and the shutter 342 are part of the window 314.

The method 400 continues, in block 420, with the device detecting selection of the physical object including detecting a gaze directed to the physical object. For example, in FIG. 2B, the gaze of the user is directed to the front door 212. As another example, in FIG. 3B, the gaze of the user is directed to the ceiling fixture 313. As another example, in FIG. 3D, the gaze of the user is directed to the window 314. As another example, in FIG. 3H, the gaze of the user is directed to the floor lamp 315.

In various implementations, detecting selection of the physical object includes detecting the gaze directed to the physical object for at least a threshold amount of time. In various implementations, detecting selection of the physical object includes detecting the gaze directed to the physical object concurrently with a hand gesture (e.g., a pinch gesture). In various implementations, detecting selection of the physical object includes detecting the gaze directed to the physical object concurrently with a vocal gesture (e.g., the user saying “Show me the door controls.”)

The method 400 continues, in block 430, with the device, in response to detecting selection of the physical object, concurrently displaying, on the display, a first status indicator indicating a status of the first electronic device and a second status indicator indicating a status of the second electronic device. For example, in FIG. 2B, in response to detecting selection of the front door 212, the electronic device displays the lock status indicator 232 and the porch light status indicator 234.

In various implementations, concurrently displaying the first status indicator and the second status indicator includes querying the first electronic device for the status of the first electronic device and querying the second electronic device for the status of the second electronic device. For example, in FIG. 2B, in various implementations, to display the lock status indicator 232, the electronic device transmits a query to the lock 213 for lock status information and receives lock status information indicating the lock status of the lock 213. The electronic device displays the lock status indicator 232 based on the received lock status information.

In various implementations, concurrently displaying the first status indicator and the second status indicator includes concurrently displaying the first status indicator and the second status indicator in association with the physical object. For example, in FIG. 2B, the lock status indicator 232 is within the lock status window 231 displayed over the front door 212 and the porch light status indicator 234 is within the porch light status window 233 displayed over the front door 212.

In various implementations, concurrently displaying the first status indicator and the second status indicator includes concurrently displaying a first window including the first status indicator and a second window including the second status indicator. For example, in FIG. 2B, the lock status indicator 232 is within the lock status window 231 and the porch light status indicator 234 is within a separate porch light status window 233. As another example, in FIG. 3B, the ceiling light status indicator 352 is within the ceiling light status window 351 and the ceiling fan status indicator 354 is within the separate ceiling fan status window 353.

In various implementations, concurrently displaying the first status indicator and the second status indicator includes displaying a window including the first status indicator and the second status indicator. For example, in FIG. 2E, the lock status indicator 232 and the porch light status indicator 234 are within the door status window 240. As another example, in FIG. 3C, the ceiling light status icon 362 and the ceiling fan status icon 363 are displayed within the ceiling fixture status window 361.

In various implementations, the first status indicator is an affordance for changing the status of the first electronic device. For example, in FIG. 2C, the lock status indicator 232 is activated to change the lock status of the lock 213 from a “locked” status to an “unlocked” status.

FIG. 5 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 502 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 506, one or more communication interfaces 508 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 510, a memory 520, and one or more communication buses 504 for interconnecting these and various other components.

In some implementations, the one or more communication buses 504 include circuitry that interconnects and controls communications between system components. In some implementations, the one or more I/O devices 506 include at least one of a keyboard, a mouse, a touchpad, a joystick, one or more microphones, one or more speakers, one or more image sensors, one or more displays, and/or the like.

The memory 520 includes high-speed random-access memory, such as dynamic random-access memory (DRAM), static random-access memory (SRAM), double-data-rate random-access memory (DDR RAM), or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 comprises a non-transitory computer readable storage medium. In some implementations, the memory 520 or the non-transitory computer readable storage medium of the memory 520 stores the following programs, modules and data structures, or a subset thereof including an optional operating system 530 and an XR experience module 540.

The operating system 530 includes procedures for handling various basic system services and for performing hardware dependent tasks. In some implementations, the XR experience module 540 is configured to manage and coordinate one or more XR experiences for one or more users (e.g., a single XR experience for one or more users, or multiple XR experiences for respective groups of one or more users). To that end, in various implementations, the XR experience module 540 includes a data obtaining unit 542, a tracking unit 544, a coordination unit 546, and a data transmitting unit 548.

In some implementations, the data obtaining unit 542 is configured to obtain data (e.g., presentation data, interaction data, sensor data, location data, etc.) from at least the electronic device 120 of FIG. 1. To that end, in various implementations, the data obtaining unit 542 includes instructions and/or logic therefor, and heuristics and metadata therefor.

In some implementations, the tracking unit 544 is configured to map the physical environment 105 and to track the position/location of at least the electronic device 120 with respect to the physical environment 105 of FIG. 1. To that end, in various implementations, the tracking unit 544 includes instructions and/or logic therefor, and heuristics and metadata therefor.

In some implementations, the coordination unit 546 is configured to manage and coordinate the XR experience presented to the user by the electronic device 120. To that end, in various implementations, the coordination unit 546 includes instructions and/or logic therefor, and heuristics and metadata therefor.

In some implementations, the data transmitting unit 548 is configured to transmit data (e.g., presentation data, location data, etc.) to at least the electronic device 120. To that end, in various implementations, the data transmitting unit 548 includes instructions and/or logic therefor, and heuristics and metadata therefor.

Although the data obtaining unit 542, the tracking unit 544, the coordination unit 546, and the data transmitting unit 548 are shown as residing on a single device (e.g., the controller 110), it should be understood that in other implementations, any combination of the data obtaining unit 542, the tracking unit 544, the coordination unit 546, and the data transmitting unit 548 may be located in separate computing devices.

Moreover, FIG. 5 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 5 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 6 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 602 (e.g., microprocessors, ASICs, FPGAs, GPUs, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 610, one or more XR displays 612, one or more optional interior- and/or exterior-facing image sensors 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 612 are configured to provide the XR experience to the user. In some implementations, the one or more XR displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 612 correspond to diffractive, reflective, polarized, holographic, etc. waveguide displays. For example, the electronic device 120 includes a single XR display. In another example, the electronic device includes an XR display for each eye of the user. In some implementations, the one or more XR displays 612 are capable of presenting MR and VR content.

In some implementations, the one or more image sensors 614 are configured to obtain image data that corresponds to at least a portion of the face of the user that includes the eyes of the user (any may be referred to as an eye-tracking camera). In some implementations, the one or more image sensors 614 are configured to be forward-facing so as to obtain image data that corresponds to the physical environment as would be viewed by the user if the electronic device 120 was not present (and may be referred to as a scene camera). The one or more optional image sensors 614 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 comprises a non-transitory computer readable storage medium. In some implementations, the memory 620 or the non-transitory computer readable storage medium of the memory 620 stores the following programs, modules and data structures, or a subset thereof including an optional operating system 630 and an XR presentation module 640.

The operating system 630 includes procedures for handling various basic system services and for performing hardware dependent tasks. In some implementations, the XR presentation module 640 is configured to present XR content to the user via the one or more XR displays 612. To that end, in various implementations, the XR presentation module 640 includes a data obtaining unit 642, a status determining unit 644, an XR presenting unit 646, and a data transmitting unit 648.

In some implementations, the data obtaining unit 642 is configured to obtain data (e.g., presentation data, interaction data, sensor data, location data, etc.) from at least the controller 110 of FIG. 1. To that end, in various implementations, the data obtaining unit 642 includes instructions and/or logic therefor, and heuristics and metadata therefor.

In some implementations, the status determining unit 644 is configured to determining one or more statuses of one or more electronic devices. To that end, in various implementations, the status determining unit 644 includes instructions and/or logic therefor, and heuristics and metadata therefor.

In some implementations, the XR presenting unit 646 is configured to concurrently display, via the one or more XR displays 612, multiple status indicators associated with a physical object. To that end, in various implementations, the XR presenting unit 646 includes instructions and/or logic therefor, and heuristics and metadata therefor.

In some implementations, the data transmitting unit 648 is configured to transmit data (e.g., presentation data, location data, etc.) to at least the controller 110. In some implementations, the data transmitting unit 648 is configured to transmit authentication credentials to the electronic device. To that end, in various implementations, the data transmitting unit 648 includes instructions and/or logic therefor, and heuristics and metadata therefor.

Although the data obtaining unit 642, the status determining unit 644, the XR presenting unit 646, and the data transmitting unit 648 are shown as residing on a single device (e.g., the electronic device 120), it should be understood that in other implementations, any combination of the data obtaining unit 642, the status determining unit 644, the XR presenting unit 646, and the data transmitting unit 648 may be located in separate computing devices.

Moreover, FIG. 6 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including a display, non-transitory memory and one or more processors:
associating a first electronic device and a second electronic device with a physical object;
detecting selection of the physical object including detecting a gaze directed to the physical object; and
in response to detecting selection of the physical object, concurrently displaying, on the display, a first status indicator indicating a status of the first electronic device and a second status indicator indicating a status of the second electronic device.

2. The method of claim 1, wherein the first electronic device has a first device type and the second electronic device had a second device type different than the first device type.

3. The method of claim 1, wherein the status of the first electronic device is a first status type and the status of the second electronic device is a second status type.

4. The method of claim 1, wherein the first electronic device and the second electronic device are within a threshold distance of the physical object.

5. The method of claim 1, wherein the first electronic device and the second electronic device are within the physical object.

6. The method of claim 1, wherein associating the first electronic device and the second electronic device with the physical object includes associating an identifier of the first electronic device and an identifier of the second electronic device with an object model of the physical object.

7. The method of claim 1, wherein detecting selection of the physical object includes detecting the gaze directed to the physical object for at least a threshold amount of time.

8. The method of claim 1, wherein detecting selection of the physical object includes detecting the gaze directed to the physical object concurrently with a hand gesture.

9. The method of claim 1, wherein detecting selection of the physical object includes detecting the gaze directed to the physical object concurrently with a vocal gesture.

10. The method of claim 1, wherein concurrently displaying the first status indicator and the second status indicator includes querying the first electronic device for the status of the first electronic device and querying the second electronic device for the status of the second electronic device.

11. The method of claim 1, wherein concurrently displaying the first status indicator and the second status indicator includes concurrently displaying the first status indicator and the second status indicator in association with the physical object.

12. The method of claim 1, wherein concurrently displaying the first status indicator and the second status indicator includes concurrently displaying a first window including the first status indicator and a second window including the second status indicator.

13. The method of claim 1, wherein concurrently displaying the first status indicator and the second status indicator includes displaying a window including the first status indicator and the second status indicator.

14. The method of claim 1, wherein the first status indicator is an affordance for changing the status of the first electronic device.

15. A device comprising:
a display;
a non-transitory memory; and
one or more processors to:
associate a first electronic device and a second electronic device with a physical object;
detect selection of the physical object including detecting a gaze directed to the physical object; and
in response to detecting selection of the physical object, concurrently display, on the display, a first status indicator indicating a status of the first electronic device and a second status indicator indicating a status of the second electronic device.

16. The device of claim 15, wherein the first electronic device has a first device type and the second electronic device had a second device type different than the first device type.

17. The device of claim 15, wherein the first electronic device and the second electronic device are within a threshold distance of the physical object.

18. The device of claim 15, wherein the one or more processors are to associate the first electronic device and the second electronic device with the physical object by associating an identifier of the first electronic device and an identifier of the second electronic device with an object model of the physical object.

19. The device of claim 15, wherein the one or more processors are to concurrently display the first status indicator and the second status indicator by concurrently displaying the first status indicator and the second status indicator in association with the physical object.

20. A non-transitory memory storing one or more programs, which, when executed by one or more processors of a device including a display, cause the device to:
associate a first electronic device and a second electronic device with a physical object;
detect selection of the physical object including detecting a gaze directed to the physical object; and
in response to detecting selection of the physical object, concurrently display, on the display, a first status indicator indicating a status of the first electronic device and a second status indicator indicating a status of the second electronic device.
